(19) United States
(12) Patent Application Publication
(10) Pub. No.: US 2014/0339395 A1
(43) Pub. Date: Nov. 20, 2014

(54) MOLD INSERT FOR AN INJECTION MOLD

(71) Applicant: Zahoransky AG, Todtnau (DE)

(72) Inventors: Ingo Kumpf, Todtnau (DE); Bernhard Rees, Aitern (DE); Florian Kiefer, Frohnd (DE)

(73) Assignee: ZAHORANSKY AG, Todtnau (DE)

(21) Appl. No.: 14/270,729

(22) Filed: May 6, 2014

(30) Foreign Application Priority Data
May 16, 2013 (DE) 102013008421.0

(51) Int. Cl. B29C 45/17

(52) U.S. Cl. CPC B29C 45/17; B29C 2045/1784
USPC 249/177

(57) ABSTRACT

A mold insert (1) for an injection mold, having a forming region (4) for forming a brush part-body (21) and having receiving holes, extending into the forming region (4), for bristle bundles (7), is configured in multiple parts. The mold insert (1) here includes a first mold-insert part (2), having the forming region (4) for the brush part-body (21) and having partial receiving holes (5) for region-wise receiving of bristle bundles (7), and a second mold-insert part (3), having partial receiving holes (6) which, in the use position, adjoin the partial receiving holes (5) of the first mold-insert part (2).

### INCORPORATION BY REFERENCE

The following documents are incorporated herein by reference as if fully set forth: German Patent Application No. 102013008421.0, filed May 16, 2013

### BACKGROUND

The invention relates to a mold insert for an injection mold, having a forming region for forming a brush part-body and having receiving holes, extending into the forming region, for bristle bundles.

Such mold inserts are known, for example from U.S. Pat. No. 6,352,313 B1. These mold inserts which are used as cassettes, are populated with bristle bundles and inserted into a forming cavity of an injection mold, such that, together with the remaining injection mold, the mold insert forms a complete mold cavity for injection-molding a brush body. In the course of injecting plastic material into the mold cavity, the bristle ends, which protrude into the forming region of the brush part-body of the mold insert, of the bristle bundles, which are arranged in the receiving holes, are overmolded and, in this manner, are connected to the molded brush body.

In order to be able to simultaneously injection-mold a plurality of brushes, in many cases a plurality of mold inserts are inserted into multiple molds. To this end, as shown, for example, in U.S. Pat. No. 6,352,313 B1, the individual mold inserts are inserted into a carrier part which is then inserted into the multiple mold.

The manufacture of mold inserts is associated with high pattern-specific costs. High requirements in terms of quality and dimensional accuracy exist, in particular, in the region of the forming region and the transitions from the forming region to the receiving holes. For this reason, mold inserts are often manufactured by way of wire cutting which, however, is complex, time-consuming and, therefore, expensive. If brushes having varying characteristics, for example a bristle array in various arrangements, are to be manufactured, special mold inserts are accordingly required for each brush. This also applies when only small modifications are to be made, for example, if the inclination of individual bristle bundles has to be modified. It is likewise necessary to adapt the introduction device and assigned pin packages with which the bristle bundles are inserted into the mold insert from the side which faces away from the forming region to the respective bristle pattern, which is again associated with high costs.

### SUMMARY

The object exists, therefore, to provide, in particular, a mold insert of the type mentioned at the outset, which can be manufactured in a simple and cost-effective manner and with which pattern changeovers for the manufacture of various brushes are possible in a simpler manner.

The object is achieved according to the invention in that the mold insert is configured in multiple parts and includes a first mold-insert part, having the forming region for the brush part-body and having partial receiving holes for the region-wise receiving of bristle bundles, and a second mold-insert part, having partial receiving holes which, in the use position, adjoin the partial receiving holes of the first mold-insert part.

The high requirements in terms of quality and dimensional accuracy exist only on the forming region of the mold insert. It is, therefore, sufficient for the first mold-insert part to be manufactured with appropriate precision, for example by way of a wire-cutting method. The second mold-insert part which, in practical terms, includes the extension of the partial receiving holes of the first mold insert may be manufactured by way of other, less complex and, therefore, more cost-effective methods.

The time required for machining a workpiece on a wire-cutting machine very much depends on the thickness of the workpiece. Since the first mold-insert part, in comparison with the entire mold insert, may be designed to be thin, it can also be manufactured more rapidly and, therefore, more cost-effectively, on account of which the costs for the entire mold insert are reduced.

Time may be additionally saved in the manufacture of the narrow first mold-insert parts in that a plurality of workpieces are clamped on top of one another and then simultaneously machined. On account of this method, which is referred to as a piggyback method, the set-up costs are reduced considerably and the mold insert according to the invention can be manufactured in a particularly cost-effective manner.

The second mold-insert part may be comprised of plastic, on account of which the costs for the entire mold insert can be reduced further. The second mold-insert part here may also be manufactured by way of, for example, a 3D printing method.

Alternatively, the second mold-insert part may also be composed of metal, and the partial receiving holes may be milled or drilled.

In the simplest case, the two mold-insert parts may be adhesively bonded to one another or welded to one another.

In order to achieve a precise mutual alignment of the two mold-insert parts in a simple manner, adjustment pins, which engage in recesses of the first mold-insert part and which are fixedly attachable in the recesses, may be provided on the second mold-insert part. The two mold-insert parts may be mutually aligned by means of a gauge and subsequently be fixed to one another by fixedly attaching the adjustment pins in the recesses.

A preferred embodiment provides here that the adjustment pins are formed of plastic and are connectable to the recesses of the first mold-insert part by way of incipient melting. Incipient melting may take place, for example, by way of a hot plate. The adjustment pins may be dimensioned, in particular, such that they initially project beyond the recesses and are shortened to the level of the recesses by incipient melting. In the case of such a connection, the two mold-insert parts are not detachable again from one another without damaging the second mold-insert part.

It is also conceivable for the adjustment pins to be provided on the first mold-insert part and for the recesses to be provided on the second mold-insert part.

Alternatively, adjustment bushes for the axial fixed attachment of the adjustment pins in the recesses may be provided, and in each case a gap which can be filled with a filling composition may be provided between the inside wall of the recess and the adjustment bush.

In this variant, the two mold-insert parts can also be mutually aligned by means of a gauge. Thereafter, the adjustment bush is placed onto the adjustment pin, and the gap is filled with the filling composition, on account of which the two mold-insert parts are connected to one another.

The filling composition may be, in particular, a tie resin which cures rapidly and forms a fixed and secure connection. Alternatively, other materials, for example adhesive materials, may also be used.

Additionally or alternatively to the above-described types of connections, the first mold-insert part may be fixedly attachable to the second mold-insert part by a screw connection.

By way of the above-described types of connections, a secure connection of the two mold-insert parts to one another is possible, independently of the materials used in said parts and also of whether said parts are comprised of different materials.

It is expedient for the mold insert to be insertable into a cassette which has a plurality of recesses for receiving in each case one mold insert and which forms a mold-insert carrier. In this manner, a plurality of mold inserts can be inserted into a multiple injection mold in a fast and simple manner and be conveyed between processing stations.

The first mold-insert part may preferably be releasably connectable to the cassette by way of a screw connection. This enables a simple but nevertheless secure and positionally stable fixed attachment of the mold inserts on the cassette, since both the first mold-insert part and the cassette in each case are usually composed of metal. Here, the second mold-insert part is in each case only connected to the assigned first mold-insert part, and not directly to the cassette.

A further concept of the invention provides that the forming region for the brush part-body of the first mold-insert part is configured to receive a bristle-carrier plate. On the finished brush, the bristle-carrier plate forms an additional material component in the region of the bristle base, which additional material component may also project laterally beyond the molded brush body. Therefore, multi-colored brush bodies may also be manufactured, without having to overmold the injection-molded brush body using a further material component.

In this embodiment, the bristle bundles are introduced into the mold insert at the free ends of the partial receiving holes of the second mold-insert part, and, with the fastening-side ends of said bristle bundles, are introduced into the forming region through the partial receiving holes of the first mold-insert part and the through openings of the bristle-carrier plate. Prior to closing the injection mold, the fastening-side ends of the bristle bundles may be incipiently molten, so that said ends are better anchored in the injection-molding material during the injection-molding.

It is advantageous for the partial receiving holes of the first mold-insert part to have in each case a bevel on their end which faces toward the second mold-insert part. On the one hand, this facilitates the introduction of the bristle bundle into the partial receiving holes. On the other hand, manufacture of the first mold-insert part can be simplified and shortened by the bevels initially being incorporated by way of milling and, subsequently, the remaining partial receiving holes being incorporated by wire cutting, for example. On account of the machining width having been reduced by the expansiveness of the bevels, the cutting time for wire cutting can be further reduced.

It may be particularly expedient here for the bevel of a partial receiving hole of the first mold-insert part, with respect to the main direction of the extent of the partial receiving hole, to be larger than the remaining portion of the partial receiving hole. Here, the usually cylindrical portion which adjoins the bevel may be configured to be very small, such that, on the one hand, this portion may be incorporated into the first mold-insert part very rapidly. Due to this, on the other hand, the bevel, on its introduction-side end, may be significantly widened in relation to the end of the partial receiving hole which faces toward the forming region, which simplifies the introduction of a bristle bundle, in particular in an oblique alignment.

In the event that obliquely arranged bristle bundles are desired in the bristle arrangement of the finished brush, it is expedient for individual or all partial receiving holes of the first mold-insert part to be arranged obliquely. In this case, the bristle bundles are held in the position desired in each case in the partial receiving holes, so that bristle arrangements having bristle bundles standing correspondingly obliquely are implementable.

It may be additionally expedient for individual or all partial receiving holes of the second mold-insert part, at least in the region which faces toward the first mold-insert part, to be arranged to run in an oblique manner. Due to the oblique introduction of a bristle bundle into a beveled partial receiving hole of the first mold-insert part, this bristle bundle maintains this oblique position on its connection-side end which protrudes into the forming region. Due to the incipient melting of the connection-side end of the bundle and the overmolding of the incipiently molten end of the bundle, the oblique alignment of the bundle is maintained also after removal from the mold insert. Therefore, it is not necessary for the respective partial receiving hole of the first mold-insert part to be itself arranged obliquely. Based on the possibility of configuring the respective partial receiving holes in a straight manner also for bristle bundles that are to be arranged obliquely, here a plurality of first mold-insert parts can also be manufactured with the above-described piggyback method, which simplifies and accelerates their manufacture.

In this context, it is particularly expedient for individual or all partial receiving holes of the second mold-insert part, at least in portions, to have an angled or curved profile and for the partial receiving holes, in their introduction region which faces away from the first mold-insert part, to be in each case arranged perpendicularly to the surface of the second mold-insert part.

On the one hand, this enables the partial receiving holes of the second mold-insert part for obliquely arranged bristle bundles to be disengaged from one another. For example, by way of a partial receiving hole which obliquely runs toward the first mold-insert part and which, in its course toward the introduction region, is subjected to a change of direction and, at the introduction region, is arranged perpendicularly to the surface of the second mold-insert part, a bristle bundle which, on its free end, overlaps with neighboring bristle bundles may be produced on the finished brush.

On the other hand, introduction of the bristle bundles into the partial receiving holes of the second mold-insert part is substantially simplified when all partial receiving holes are arranged perpendicularly to the surface of the second mold-insert part. The bristle bundles to be fed may be arranged in an introduction device having straight receiving openings for the bristle bundles. Here, the receiving openings of the introduction device are aligned to be flush with the introduction-side openings of the partial receiving holes of the second mold-insert part. Therefore, the bristle bundles can be transferred by straight pins from the introduction device into the second mold-insert part.

It is advantageous for the partial receiving holes of the second mold-insert part, at their introduction region which faces away from the first mold-insert part, to be spaced apart at greater distances than at their region which faces toward the first mold-insert part.

Depending on the material and execution of an introduction device for the bristle bundles, the receiving openings of said device have to have a specific minimum spacing. By way of a curved profile of the partial receiving holes of the second mold-insert part, the bristle bundles may be introduced into the correspondingly arranged partial receiving holes of the first mold-insert part using a reduced spacing, that is to say a higher bristle density, in contrast to said partial receiving holes of the second mold-insert part.

A further embodiment provides that partial receiving holes of the second mold-insert part have a variation in their cross section from their introduction region which faces away from the first mold-insert part up to the region which faces toward the first mold-insert part. In this manner, for example, bristle bundles having a round cross section can be re-shaped into bristle bundles having a rectangular cross section.

It is also possible to bring together a plurality of bristle bundles to form one larger bristle bundle, in that a partial receiving hole is configured to branch out in a Y shape.

In particular in the case of second mold-insert parts having an angled or curved profile of the partial receiving holes, it may be expedient for the second mold-insert part to be configured in multiple parts.

The second mold-insert part, in the main direction of extent of the partial receiving holes, may be subdivided, such that the respective portions of the partial receiving holes are configured to be at least largely linear and can be manufactured by way of simple methods, such as milling or drilling.

### BRIEF DESCRIPTION OF THE DRAWINGS

In the following, exemplary embodiments of the mold insert according to the invention are described in more detail on the basis of the drawings. In the drawings, in some cases in a schematic manner:

FIG. 1 shows four mold inserts held in a cassette, having molded brush bodies,

FIG. 2 shows a portion of the cassette of FIG. 1,

FIG. 2A shows a detailed illustration from FIG. 2,

FIG. 3 shows a cross section of a mold insert held in a cassette, and an introduction device,

FIG. 4 shows a view similar to that of FIG. 2, having a bristle-carrier plate,

FIG. 4A shows a detailed illustration from FIG. 4,

FIG. 5 shows a cross section of a mold insert held in a cassette, having a bristle-carrier plate and an introduction device,

FIG. 6 shows a brush having bristle bundles aligned in various manners,

FIG. 7 shows various specifications of a mold insert, in each case having an injection-molded brush body, and

FIG. 8 shows a schematic illustration of individual work stations when manufacturing a brush.

### DETAILED DESCRIPTION OF THE PREFERRED EMBODIMENTS

A mold insert which, in its entirety, is designated 1 is configured in multiple parts, according to FIG. 3, and includes a first mold-insert part 2 and a second mold-insert part 3. The first mold-insert part 2 includes a forming region 4 for forming a brush part-body 21 and partial receiving holes 5 for the region-wise receiving of bristle bundles 7. The second mold-insert part 3 includes partial receiving holes 6, which adjoin the partial receiving holes 5 of the first mold-insert part 2, for the bristle bundles 7.

The mold insert 1 may be inserted into an injection mold (not illustrated) in which the forming region 4, in conjunction with a further mold part of the injection mold, is completed to form a mold cavity for a brush body 8 or a brush part-body 21. The bristle bundles 7, prior to the injection-molding operation, are pushed into the partial receiving holes 5, 6 in such a manner that their fastening-side ends protrude into the forming region 4. By way of injecting plastic material into the mold cavity, the fastening-side ends of the bristle bundles 7 are overmolded and the bristle bundles 7 are anchored in this manner in the injection-molded brush part-body 21. Optionally, prior to the injection-molding operation, the free ends of the bristle bundles 7 can be incipiently molten.

A particularly high dimensional accuracy and corresponding quality requirements are necessary only in the region of the forming region 4. In contrast thereto, a reduced level of quality may be sufficient for receiving the remaining part of the bristle bundle 7. Therefore, the first mold-insert part 2 may be configured to be comparatively thin, relative to the entire thickness of the mold insert 1, and, therefore, be manufactured more cost-effectively and in a shorter time than a single-part insert mold which, in its entirety, would have to be manufactured with expensive and time-consuming methods and materials. The second mold-insert part 3 which merely serves for receiving the major part of the bristle bundle 7 may be manufactured by way of simpler methods, for example also by way of 3D printers and from plastic and, therefore, significantly more rapidly and more cost effectively.

An introduction device 9 is provided for introducing the bristle bundles 7, which introduction device is attachable to the introduction-side end of the second mold-insert part 3. The introduction device 9 has recesses 10 for receiving the bristle bundles 7. The bristle bundles 7 may be pushed into the partial receiving holes 6 of the second mold-insert part 3 by way of pins (not illustrated) until the fastening-side ends of the bristle bundles 7 also penetrate the partial receiving holes 5 of the first mold-insert part 2 and protrude into the forming region 4. In order to simplify the introduction of the bristle bundles 7, introduction bevels 22 are in each case provided on the infeed-side ends of the recesses 10 and of the partial receiving holes 6 of the second mold-insert part 3.

The fastening-side ends of the bristle bundles 7 may then be incipiently molten, and the mold-insert 1 may be inserted into an injection mold (not illustrated).

The individual partial receiving holes 5, 6 in the mold insert 1, shown according to FIG. 3, clarify various possibilities of designing the partial receiving holes 5, 6 and therefore of arranging and aligning the bristle bundles 7 in the finished brush 19.

In the region designated I, the partial receiving holes 5, 6 of the two mold-insert parts 2, 3 are in each case configured in a straight manner, such that the bristle bundle 7 protrudes on the finished brush from the brush part-body 21 at a right angle in a likewise straight manner. On its side facing toward the second mold-insert part 3, the assigned partial receiving hole 5 of the first mold-insert part 2 has a bevel 11, in order to facilitate the transition of the bristle bundle 7 between the two partial receiving holes 5, 6.

In order to achieve bristle bundles 7 which stand obliquely on the finished brush 19, the partial receiving holes 5 of the first mold-insert part 2, as shown in the regions VI and VII, may be introduced into the mold-insert part 2 in an oblique manner, corresponding to the desired inclination of the bundle. The assigned partial receiving holes 6 of the second mold-insert part 3, in the end region which faces toward the mold-insert part 2, are likewise configured having the corresponding inclination.

In the regions II through V, the partial receiving holes 5 of the first mold-insert part 2 include in each case an enlarged and widened bevel 11. The bevel 11, with respect to the main direction of extent of the partial receiving hole, is in each case significantly larger than the remaining portion of the partial receiving hole 5.

Due to this, bristle bundles 7 having various angular positions can be fed. Due to the incipient melting of the fastening-side free bundle ends, the individual bristle filaments of a bristle bundle 7 are fixedly attached relative to one another, so that the inclination of the entire bristle bundle 7 is maintained even after the removal of the finished brush 19 from the mold insert 1.

Here, the inclination of the bristle bundle 7 is predetermined by the alignment of the respective partial receiving hole 6 of the second mold-insert part 3. Therefore, solely by the arrangement of the partial receiving holes 6 of the second mold-insert part 3, various bristle arrangements having differently aligned bristle bundles 7 can be produced in the case of an identical design of the partial receiving holes 5 of the first mold-insert part 2. Since the first mold-insert part 2 can be employed for various brushes and merely the second mold-insert part 3, which is simply and cost-effectively manufacturable, has to be replaced, different brushes may be manufactured in a cost-effective and comparatively simple manner.

It is illustrated in the region II that perpendicularly arranged bristle bundles 7 can be achieved even in the case of a partial receiving hole 5 having a large bevel 11.

It can be seen in the regions III and IV that, in the case of partial receiving holes 5 of the same type in the first mold-insert part 2, different bundle inclinations can be achieved by way of a corresponding arrangement and alignment of the partial receiving holes 6 in the second mold-insert part 3.

In the region V, an axial offset is achieved between the partial receiving hole 5 of the first mold-insert part 2 and the assigned recess 10 of the introduction device 9 by way of a curved profile of the partial receiving hole 6 in the second mold-insert part 3. Therefore, bristle arrangements having, for example, closely neighboring bristle bundles 7 may be implemented even when the recesses 10 of the introduction device 9 have to have a specific minimum spacing from one another. The spacing of the partial receiving holes 5 of the first mold-insert part 2 may thus be significantly smaller than the spacing of the recesses 10 of the introduction device 9.

Due to the angled or curved profile of the partial receiving holes 6 of the second mold-insert part 3, these receiving holes, in the infeed region for the bristle bundle 7, are in each case arranged perpendicularly to the surface of the second mold-insert part 3, such that all bristle bundles 7 can be introduced in a uniform, straight direction. Introducing the bristle bundles 7 into the partial receiving holes 6 is therefore possible in a simple and rapid manner by the use of straight introduction pins which are arranged parallel to one another.

A brush 19, such as can be manufactured with a mold insert 1 according to FIG. 3, is shown in FIG. 6, the brush body 8 being illustrated only in regions. It also becomes clear here that individual bristle bundles 7 may mutually overlap, which cannot be implemented with previously known mold inserts.

A plurality of mold inserts 1 may be inserted into a cassette 12, which can then be inserted into a multiple injection mold.

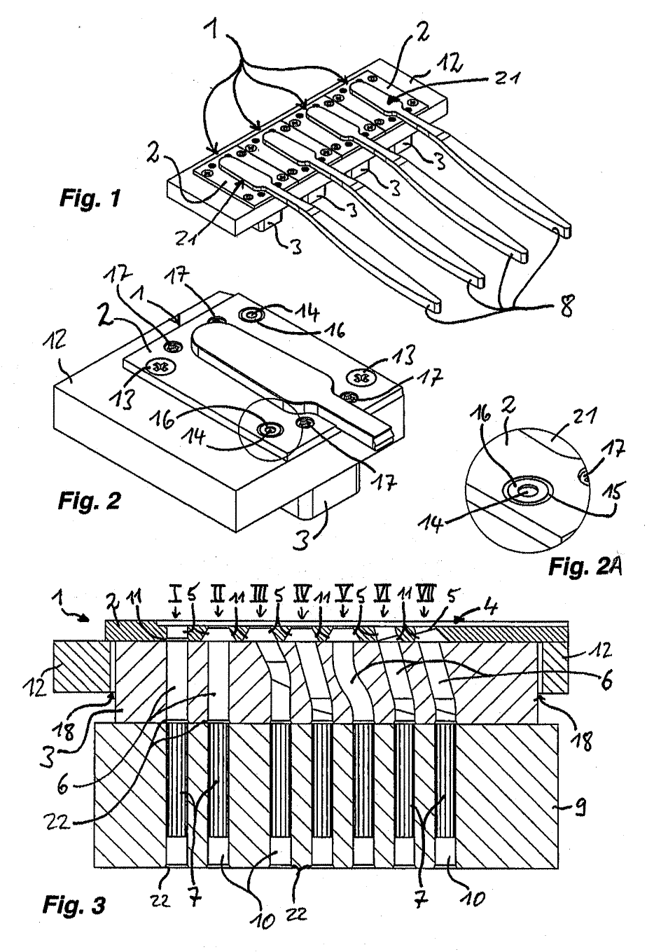

Such a cassette 12 having four mold inserts 1 is illustrated in FIG. 1. In the case of this illustration, the brush bodies 8 have already been molded on.

FIG. 2 shows, in an enlarged manner, the left portion of the cassette 12 from FIG. 1, and FIG. 2A, in turn, shows a detailed enlargement of the circled region from FIG. 2.

For connecting the two mold-insert parts 2, 3 to one another, adjustment pins 14 which engage in recesses 15 of the first mold-insert part 2 are provided on the second mold-insert part 3. The adjustment pins 14 may be composed of, for example, steel and be connected to the second mold-insert part 3 via an adhesive connection. The first mold-insert part 2 and the second mold-insert part 3 may be mutually aligned in the desired position by means of a gauge. The two mold-insert parts 2, 3 are attached to one another in a rough manner by means of adjustment bushes 16 which are imposed over the adjustment pins 14. The intermediate space remaining between the adjustment bush 16 and the inside wall of the recess 15 is filled with a filling compound, for example a tie resin, which, after curing, forms a fixed connection between the mold-insert parts 2, 3. Additionally, the two mold-insert parts 2, 3 may be connected to one another by screws 17. Optionally, a connection solely by way of the screws 17 may be sufficient.

The first mold-insert parts 2 are in each case connected to the cassette 12 by screws 13. However, there is no direct connection between the cassette 12 and the second mold-insert parts 3, which is also made clear by the gap 18 between the two parts (FIG. 3).

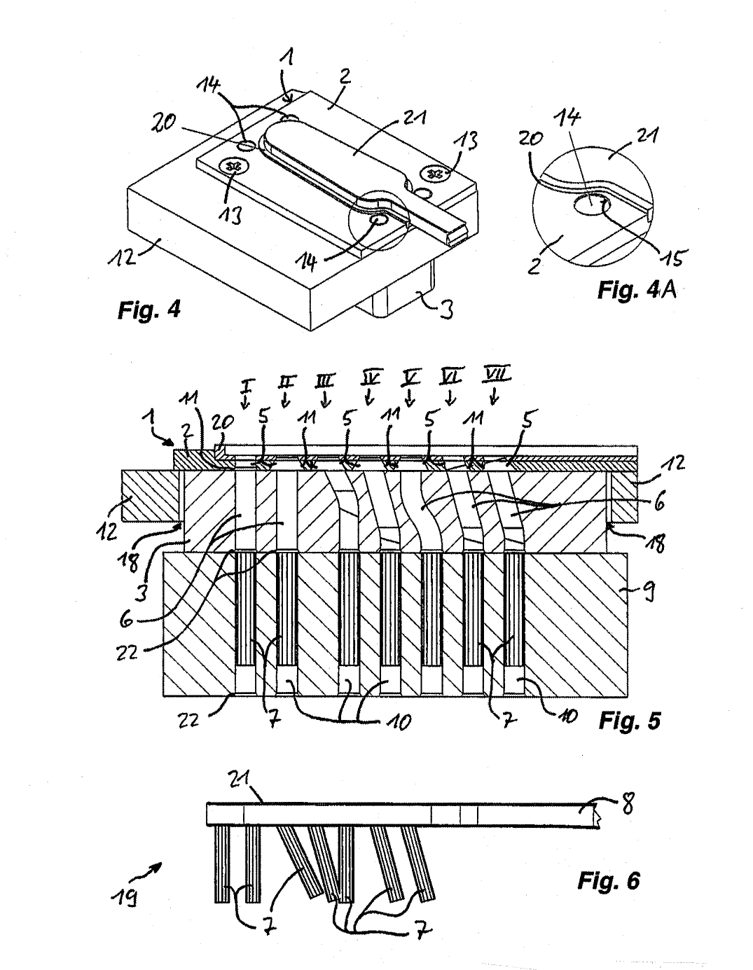

It is furthermore shown in FIGS. 4 and 5 that the forming region 4 for the brush part-body of the first mold-insert part 2 may also be configured for receiving a bristle-carrier plate 20. As can be seen to good effect in FIG. 5, said bristle-carrier plate may be inserted prior to introducing the bristle bundles 7 into the forming region 4. When being introduced, the bristle bundles 7 then also penetrate the bristle-carrier plate 20.

An alternative possibility for connecting the two mold-insert part 2, 3 to one another is shown in FIG. 4 and the detailed illustration of the circled region in 4a. Here, the adjustment pins 14, comprised of plastic, of the second mold-insert part 3 engage through recesses 15 of the first mold-insert part 2. After mutually aligning the two mold-insert parts 2, 3, the adjustment pins 14 which initially protrude beyond the surface of the first mold-insert part 2 are incipiently molten, for example via a hot plate. Here, the incipiently molten material of the adjustment pins 14 fills out the recesses 15 and leads to a connection of the two mold-insert parts 2, 3. Optionally, here too, the two mold-insert parts 2, 3 may be additionally fixed by screws which are not illustrated in FIGS. 4 and 4A.

Since, in this variant, the adjustment pins 14 are incipiently molten as part of the second mold-insert parts 3, re-use of the second mold-insert parts 3 is not possible after separating the two mold-insert parts 2, 3.

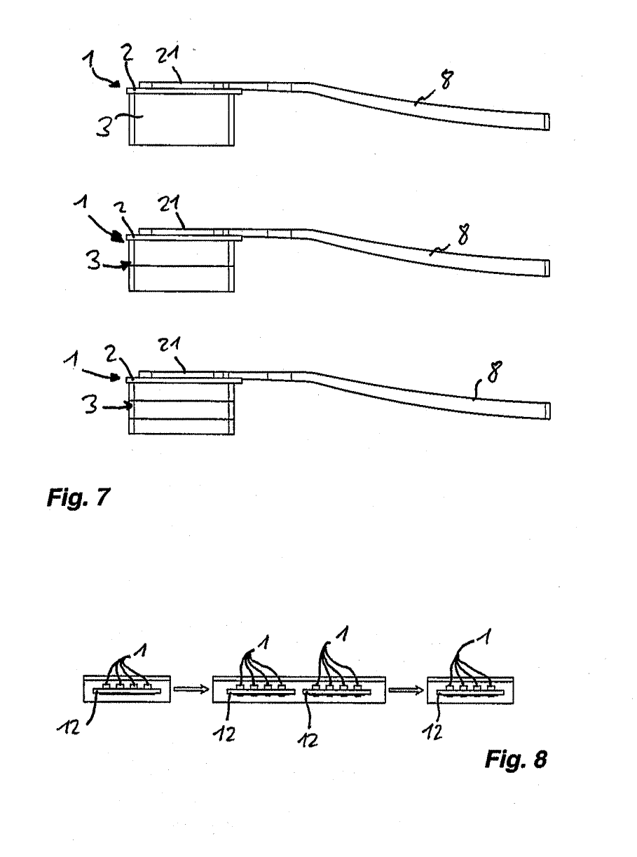

FIG. 7 illustrates that the second mold-insert part 3, itself, may be configured in multiple parts. A mold insert 1 having an already injection-molded brush body 8 is illustrated in each case. In the uppermost illustration, the second mold-insert part 3 is configured in one part, whereas it is configured in two parts in the central illustration and in three parts in the bottommost illustration. A configuration of the second mold-insert part 3 in multiple parts may be particularly expedient in the case of angled or curved partial receiving holes 6, since largely straight portions of the partial receiving holes 6 may be incorporated into the individual regions of the second mold-insert part 3, which can simplify manufacturing of said portions.

A processing sequence is schematically illustrated in FIG. 8. In the left region, mold inserts 1, which are held on a cassette 12, are populated with bristle bundles 7. Mold inserts 1 which have been populated in this manner can be inserted into an injection mold. An injection-molding machine is symbolized in the central region, into which machine two cassettes 12 having mold inserts 1, for example for injection-molding the brush body and subsequently for overmolding the brush body with a further material component which is, for example, of a different color, are inserted. A removal station, at which the finished brushes are removed from the mold inserts 1, is indicated on the right side.

1. A mold insert (1) for an injection mold, comprising a forming region (4) for forming a brush part-body (21) and having receiving holes, extending into the forming region (4), for bristle bundles (7), wherein the mold insert (1) is configured in multiple parts and includes a first mold-insert part (2), having the forming region (4) for the brush part-body (21) and having partial receiving holes (5) for region-wise receiving of bristle bundles (7), and a second mold-insert part (3), having partial receiving holes (6) which, in a use position, adjoin the partial receiving holes (5) of the first mold-insert part (2).

2. The mold insert as claimed in claim 1, wherein the second mold-insert part (3) is comprised of plastic.

3. The mold insert as claimed in claim 1, further comprising adjustment pins (14) on the second mold-insert part (3), which engage in recesses (15) of the first mold-insert part (2) and are fixedly attachable in the recesses (15).

4. The mold insert as claimed in claim 3, wherein the adjustment pins (14) are comprised of plastic and are connectable to the recesses (15) of the first mold-insert part (2) by incipient melting.

5. The mold insert as claimed in claim 3, wherein adjustment bushes (16) for an axial fixed attachment of the adjustment pins (14) in the recesses (15) are provided and in each case a gap which is filled with a filling composition is provided between an inside wall of the recess (15) and the adjustment bush (16).

6. The mold insert as claimed in claim 5, wherein the filling composition is a tie resin.

7. The mold insert as claimed in claim 1, wherein the first mold-insert part (2) is fixedly attachable on the second mold-insert part (3) by a screw connection.

8. The mold insert as claimed in claim 1, wherein the mold insert (1) is insertable into a cassette (12) which has a plurality of recesses for receiving in each case one of the mold inserts (1) and which forms a mold-insert carrier.

9. The mold insert as claimed in claim 8, wherein the first mold-insert part (2) is releasably connectable to the cassette (12) by a screw connection.

10. The mold insert as claimed in claim 1, wherein the forming region (4) for the brush part-body (21) of the first mold-insert part (2) is configured to receive a bristle-carrier plate (20).

11. The mold-insert as claimed in claim 1, wherein the partial receiving holes (5) of the first mold-insert part (2) in each case have a bevel on an end thereof which faces toward the second mold-insert part (3).

12. The mold insert as claimed in claim 11, wherein the bevel (11) of the partial receiving hole (5) of the first mold-insert part (2), with respect to a main direction of extent of the partial receiving hole (5), is larger than a remaining portion of the partial receiving hole (5).

13. The mold insert as claimed in claim 1, wherein individual ones or all of the partial receiving holes (5) of the first mold-insert part (2) are arranged obliquely.

14. The mold insert as claimed in claim 1, wherein individual ones or all of the partial receiving holes (6) of the second mold-insert part (3), at least in a region which faces toward the first mold-insert part (2), are arranged to run in an oblique manner.

15. The mold insert as claimed in claim 1, wherein individual ones or all of the partial receiving holes (6) of the second mold-insert part (3), at least in portions, have an angled or curved profile and the partial receiving holes (6) of the second mold-insert part (3), in an introduction region which faces away from the first mold-insert part (2), are in each case arranged perpendicularly to a surface of the second mold-insert part (3).

16. The mold insert as claimed in claim 1, wherein the partial receiving holes (6) of the second mold-insert part (3), at an introduction region which faces away from the first mold-insert part (2), are spaced apart at greater distances than at a region which faces toward the first mold-insert part (2).

17. The mold insert as claimed in claim 1, wherein the partial receiving holes (6) of the second mold-insert part (3) have a variation in cross section from an introduction region which faces away from the first mold-insert part (2) up to a region which faces toward the first mold-insert part (2).

18. The mold insert as claimed in claim 1, wherein the second mold-insert part (3) is configured in multiple parts.
